(19) United States
(12) Patent Application Publication
(10) Pub. No.: US 2004/0126038 A1
(43) Pub. Date: Jul. 1, 2004

(54) Method and system for automated annotation and retrieval of remote digital content

(75) Inventors: Serge Aublant, South San Francisco, CA (US); Andy Choi, South San Francisco, CA (US); Santhana Krishnasamy, South San Francisco, CA (US); Michael Smith, South San Francisco, CA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: France Telecom Research and Development LLC, South San Francisco, CA

(21) Appl. No.: 10/331,730

(22) Filed: Dec. 31, 2002

(51) Int. Cl. G06K 9/54

(52) U.S. Cl. 382/305

(57) ABSTRACT

A method and system for automated annotation and retrieval of remote digital content is described. The image capture device of the present invention is configured to communicate with one or more external devices using a wired or wireless protocol. For example, Smart tag, 802.11, or Bluetooth protocols may be used to enable the camera to communicate with the external device, associated with an object of interest, to obtain metadata corresponding to a captured image of the object. The metadata collected using various forms of technology, as noted above for instance, can be used to automatically index a digital image and/or other digital content without any manual intervention.

### BACKGROUND OF THE INVENTION

1. Field of the Invention

This invention relates generally to capturing images, as well as storing, organizing, indexing, and retrieving the captured images. More particularly, it relates to a method and system for automated annotation, indexing, and retrieval of digital content.

2. Discussion of Related Art

Digital imaging is currently experiencing a worldwide revolution of growth in both the number of users and the range of applications that are replacing traditional film photography thereby fostering new opportunities for using digital techniques. This has resulted in an ever-increasing flood of new digital images, driven by a combination of (1) high-performance, low-cost, image-capture methods, such as mega-pixel digital cameras, and (2) new film processing services, such as the option for storing traditional film images directly on a CD-ROM.

While the easy creation and availability of digital images is opening the door for expansion of application opportunities, the corresponding volume creates a new set of issues in the area of image management. These issues include finding methods for efficiently archiving, indexing, cataloging, reviewing, and retrieving the individual images. From a consumer's perspective, the issues relate to avoiding the digital equivalent of an “unorganized shoebox full of photos”, and from the perspective of businesses, it means maximizing the value and reusability of precious corporate assets in the form of well-organized and accessible image archives.

The current state of digital image management and retrieval is very rudimentary and involves manual processing to achieve the desired results. For example, one exemplary approach categorizes images by groups. In this approach, a user manages image files by storing the image files from an event under a particular folder that generalizes the activity or image content. In this approach, a common way is to categorize the folder based on the date and location of the images, or to categorize the images based on information related to Friends or Family.

In another exemplary approach, in order to get a better feel of the contents of an image, a user may review the contents of an image and then rename the image file to more closely correspond to image content. While this approach provides much more detailed information concerning the contents of an image, the time and effort required to manually rename each of the image file may be quite cumbersome.

U.S. Pat. No. 6,408,301 to Patton et al. describes an interactive image storage, indexing, and retrieval system wherein a plurality of digital images are stored in digital form. Each of the images is associated with an information file, the associated information file including metadata that is automatically captured and stored and/or input by a user. Automatically captured metadata includes things such as GPS location (associated place), attitude, altitude, direction, etc. (Col. 4, lines 29-35). However, none of these metadata characteristics of Patton et al. accurately specify the position of an image object at a given location. Further, in the absence of a GPS system, no metadata related to the physical location of an imaging subject may be obtained in the prior approaches.

Accordingly, a system and method to address the above-identified drawbacks is proposed.

### BRIEF SUMMARY OF THE INVENTION

It is therefore a feature of the invention to provide a method and system for automated annotation, indexing, and retrieval of remote digital content, wherein the position of an imaging object may be accurately specified.

An image is captured using an electronic device, such as, for example, a standalone camera or a camera embedded with other devices such as a phone, PDA, etc. The metadata of a captured image is created using technologies located within or associated with the camera. Also, content available through a network (e.g., the internet) is used to create additional metadata for accurate indexing and retrieval of captured images.

In an exemplary embodiment, in order to create metadata, a captured image is processed using image recognition software to identify the captured image, and a name associated with the identified image is obtained. Once a person captured in the image is identified, and the date and time information is determined from the captured image content, further metadata is created by establishing communication with an address book of the identified person and retrieving any additional information stored in the address book for the specified date and time ranges.

In another exemplary embodiment, metadata corresponding to a captured image is created by obtaining information related to the captured image using wired or wireless communication protocols that enable exchange or transfer of information between a camera and a communication device associated with the captured image.

In a preferred embodiment of the invention, the image capture device of the present invention is configured to communicate with one or more external devices using a wired or wireless protocol. For example, Smart tag, 802.11, or Bluetooth protocols may be used to enable the camera to communicate with the external device, associated with an object of interest, to obtain metadata corresponding to a captured image of the object. The metadata collected using various forms of technology, as noted above for instance, can be used to automatically index a digital image and/or other digital content without any manual intervention.

An advantage of using Smart tags is that, when a picture of an object (e.g., a painting having an associated Smart tag associated) is captured with a camera having an appropriate interface, the camera can collect information about the object using Smart tag protocol. This information can be correlated to the captured digital image and used to index the captured image. Similar advantages exist with the Bluetooth protocol wherein information is exchanged between the camera and the device associated with an image object when the camera is within the communication range of the device.

In one aspect, there is provided a method for image storage, indexing, and retrieval, the method includes capturing a plurality of images in digital form; storing each of the plurality of images as an image file; determining an identifier for each of the image files; communicating with at least one device for retrieving metadata stored therein corresponding to the identifier; storing metadata corresponding to at least one of the plurality of images in an index file; retrieving the stored image files by querying at least one form of metadata.

The method further includes creating a database (1) for referencing the image files of the plurality of images and (2) for storing the index file(s) associated therewith. The database can be searched to find the image files corresponding to the metadata specified. The images may be regrouped into one or more virtual groups determined by a user, and the retrieved images can be displayed on a remote or local display device via wired or wireless communications.

In another aspect, there is provided a method of storing, indexing and retrieving of a plurality of images. The method includes storing the plurality of images in digital form; determining an identifier from each of the plurality of stored images; retrieving metadata, corresponding to the identifier, from a database; and indexing the plurality of stored images using metadata obtained from the database.

In a further aspect, the present invention relates to a method for storing, indexing and retrieving digital content. The method includes storing each of a plurality of images as a digital image file; communicating with smart tag devices associated with respective objects included within images; retrieving and storing metadata for the objects from their respective smart tag devices; associating the metadata with its corresponding stored image file; and retrieving the stored image files by querying the metadata.

In a yet additional aspect, there is provided a method for storing, indexing and retrieving remote digital content, comprising storing each of a plurality of images as a digital image file; communicating with a transceiver associated with respective objects of the images; retrieving metadata for the objects from the respective transceivers; storing in an index file the retrieved metadata in relationship to its stored image; and retrieving the stored image files by querying the metadata. In one embodiment, the transceiver preferably is a Smart Tag device. In another embodiment, the transceiver is preferably configured to operate using a Bluetooth protocol.

In yet another aspect, there is provided a system for performing the method of the present invention. Such a system includes a camera for capturing one or more images and transceivers for automatically providing metadata.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1(a) is a front view of an camera used in accordance with an exemplary embodiment of the present invention;

FIG. 1(b)is a back view of the camera shown in FIG. 1(a);

FIG. 2 is a schematic of a system overview in an exemplary embodiment of the present invention;

FIG. 3 is a detailed schematic of a computer system shown in FIG. 2;

FIG. 4A is a schematic illustration of an exemplary system interface of the present invention for indexing and retrieving of information;

FIG. 4B shows an indexing and grouping scheme for images identified in FIG. 4A;

FIG. 5 shows an exemplary system architecture for a demonstration prototype according to the present invention;

FIGS. 6A, 6B, and 7 illustrate various exemplary schematics for obtaining metadata;

FIGS. 8A through 8C show file/data structures for storing image data and corresponding metadata;

FIG. 9 is a flow chart illustrating image capture, indexing, storage, and retrieval of information in an exemplary embodiment of the present invention; and

FIGS. 10 through 12 illustrate exemplary schematics showing variations of the system shown in FIG. 2.

### DETAILED DESCRIPTION OF EXEMPLARY EMBODIMENTS

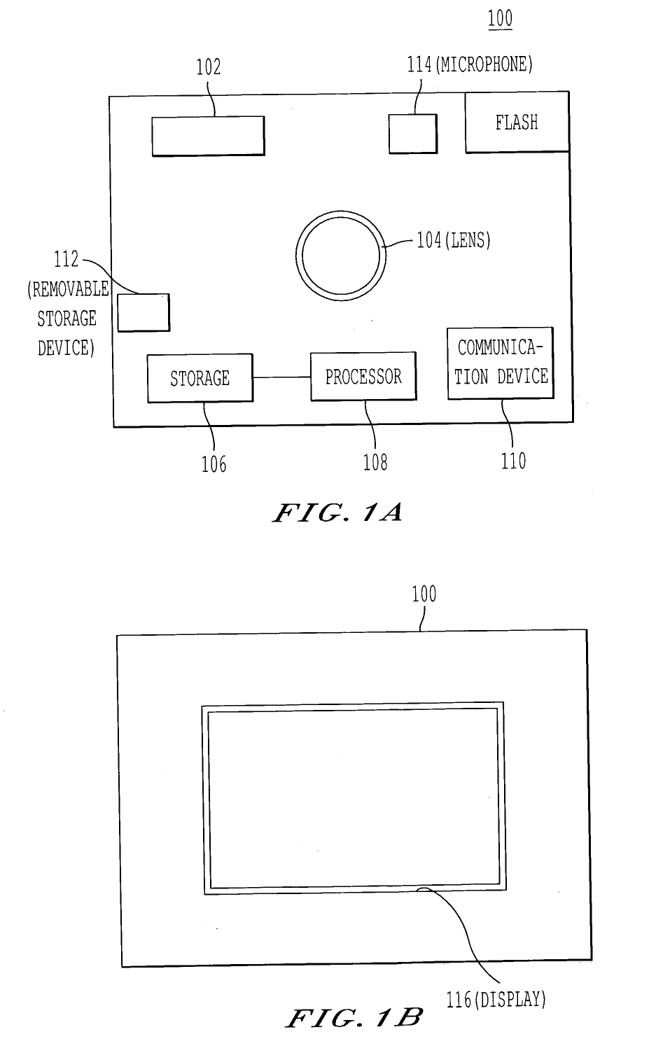

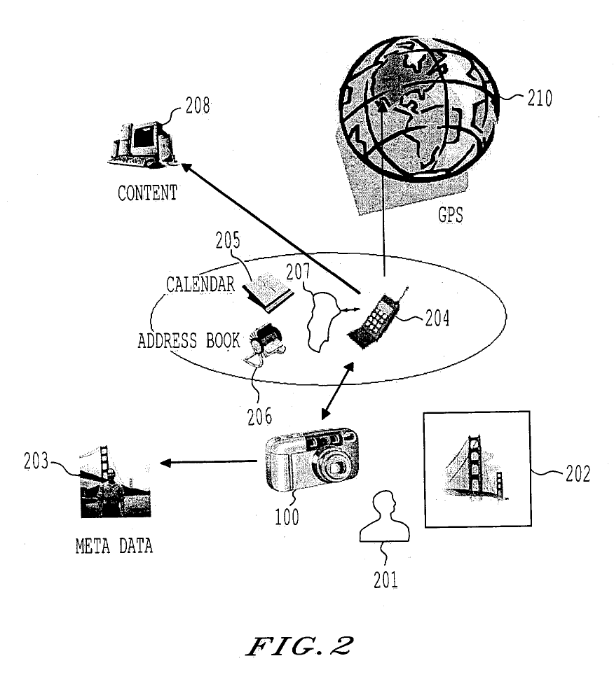

Referring to the drawings, wherein like reference numerals designate identical or corresponding parts through the several views, FIGS. 1(a) and 1(b) show a digital camera 100 having controls 102 for operating the camera 100, a lens 104 for capturing an image, a primary storage device 106 for storing digital data related to a captured image. The camera 100 includes a processor 108 for processing the data stored in the storage device. The processor 108 may be used to process captured data in order to generate metadata related to the captured data. If processing of data locally within the camera 100 is computationally intensive, then such data may be transmitted to an external computing device, such as for example, server 208 (FIG. 3) for processing and subsequent transfer of the processed information back to the camera 100, via a communications device 110, for indexing and storage locally within the storage device 106. The communications device 110, for example, may be an IR receiver, a transponder capable of communicating with a Smart Tag communications device, a communications device capable of communicating with an external device using a Bluetooth or any such communication protocol.

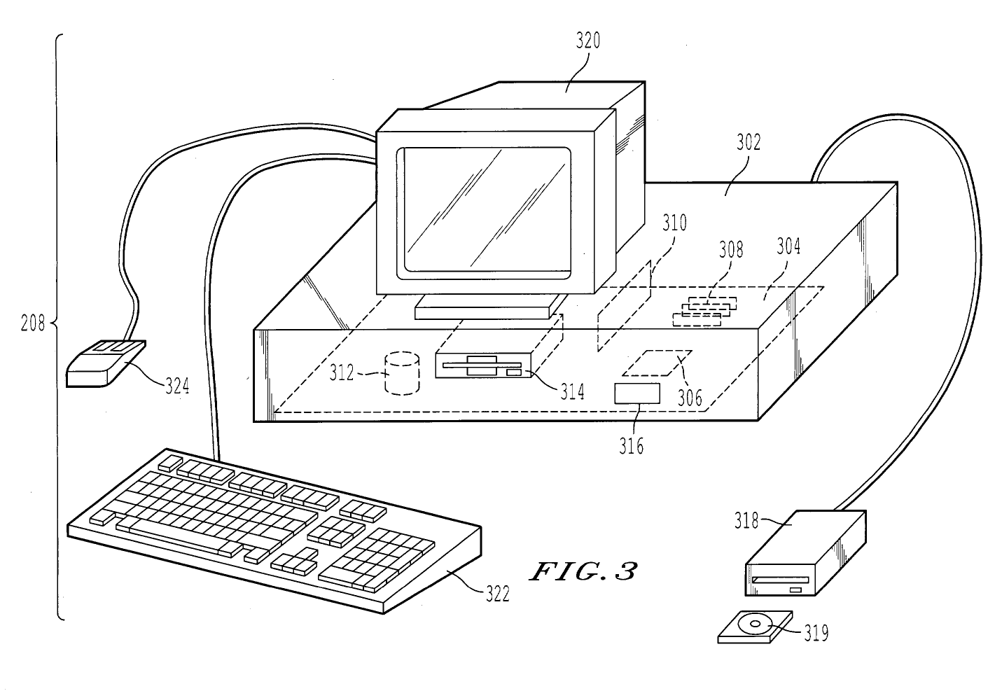

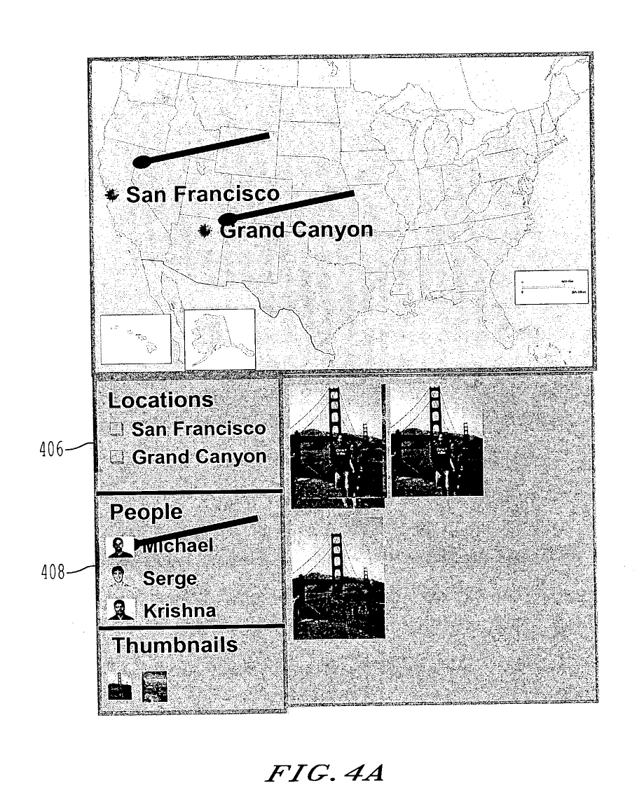

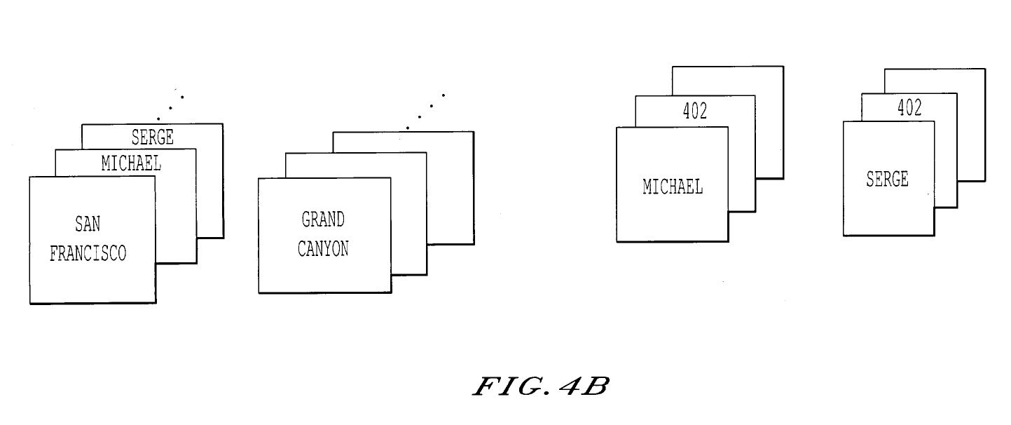

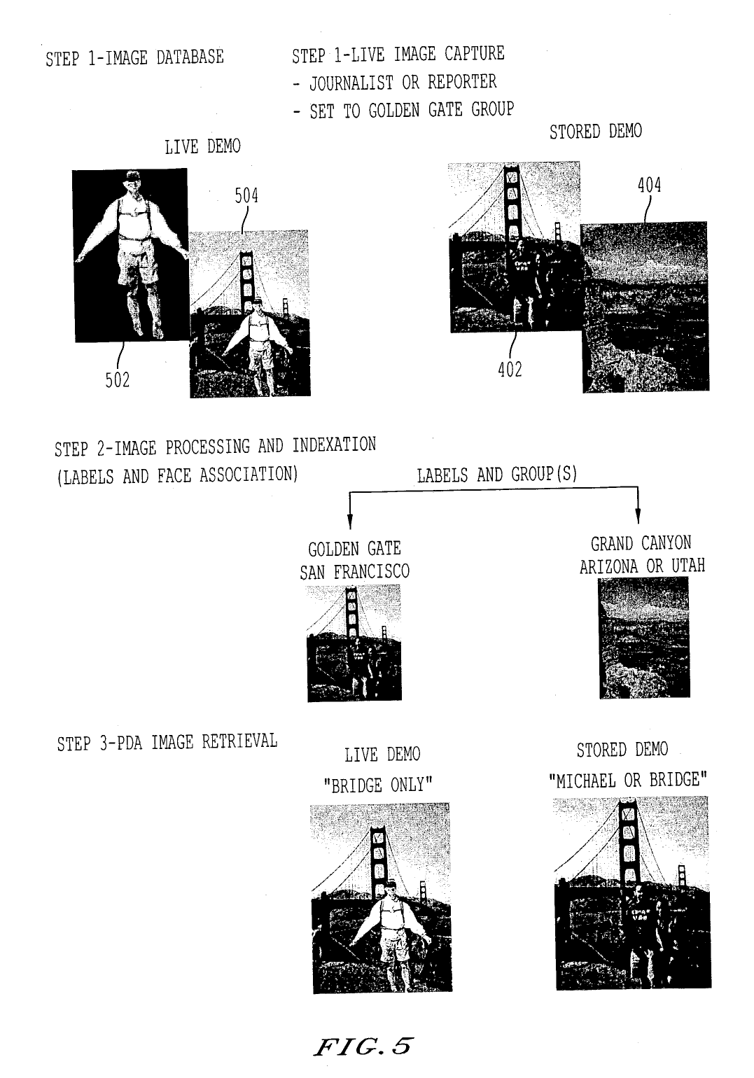

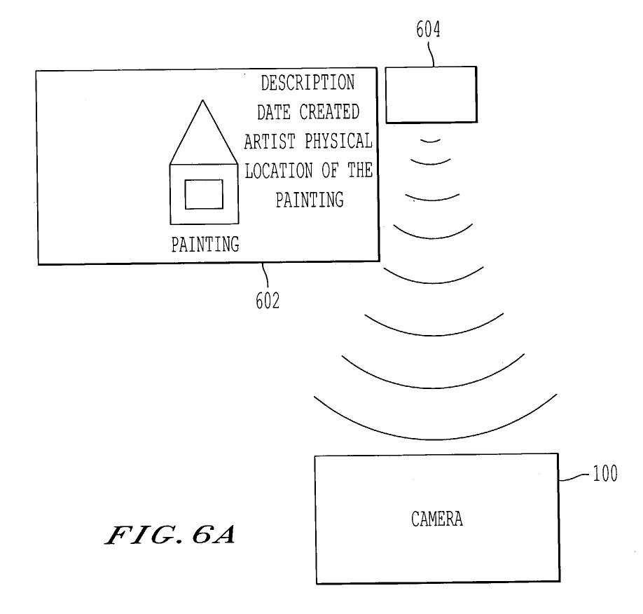

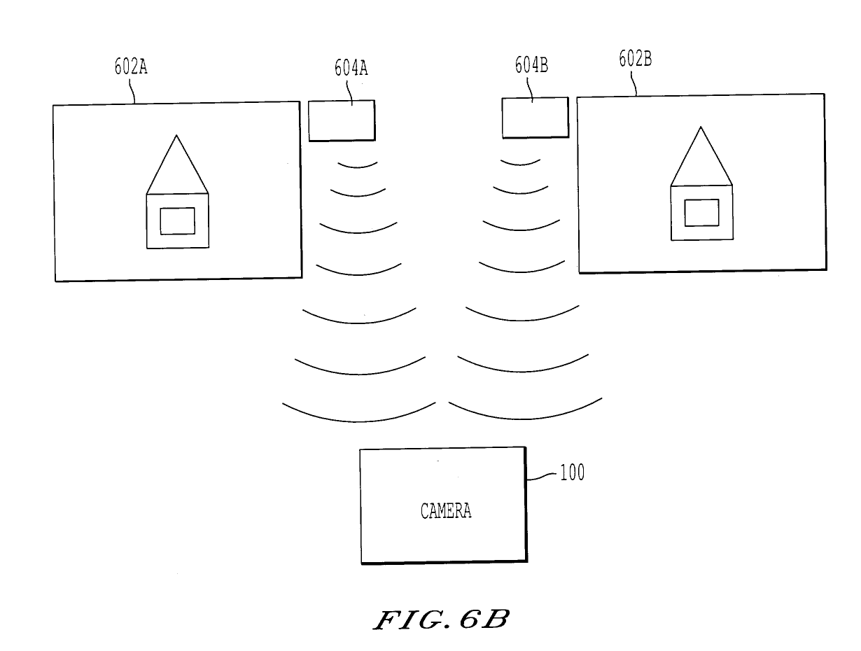

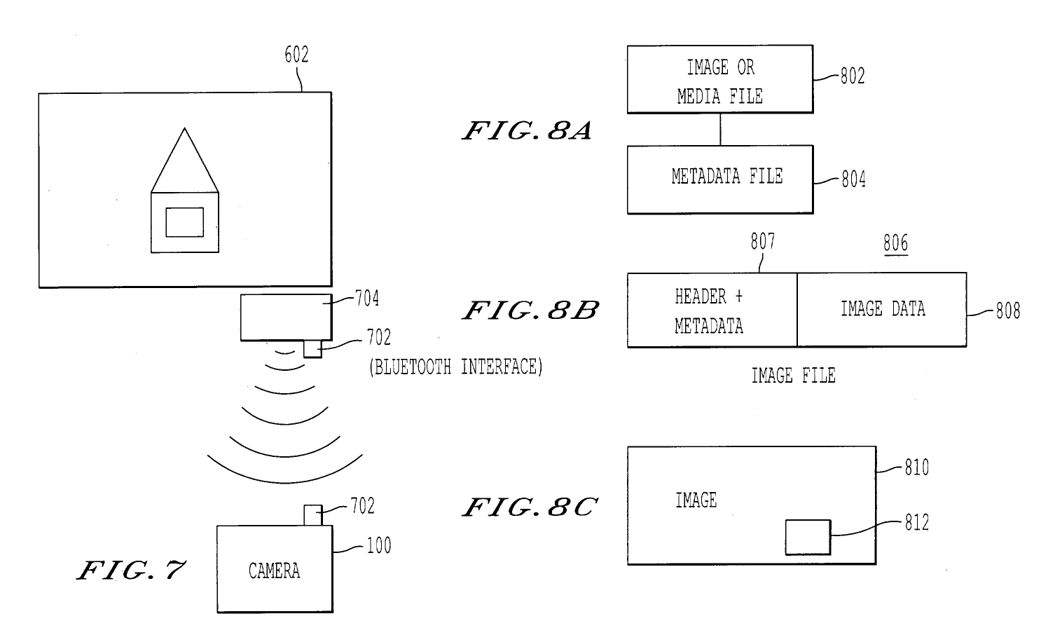

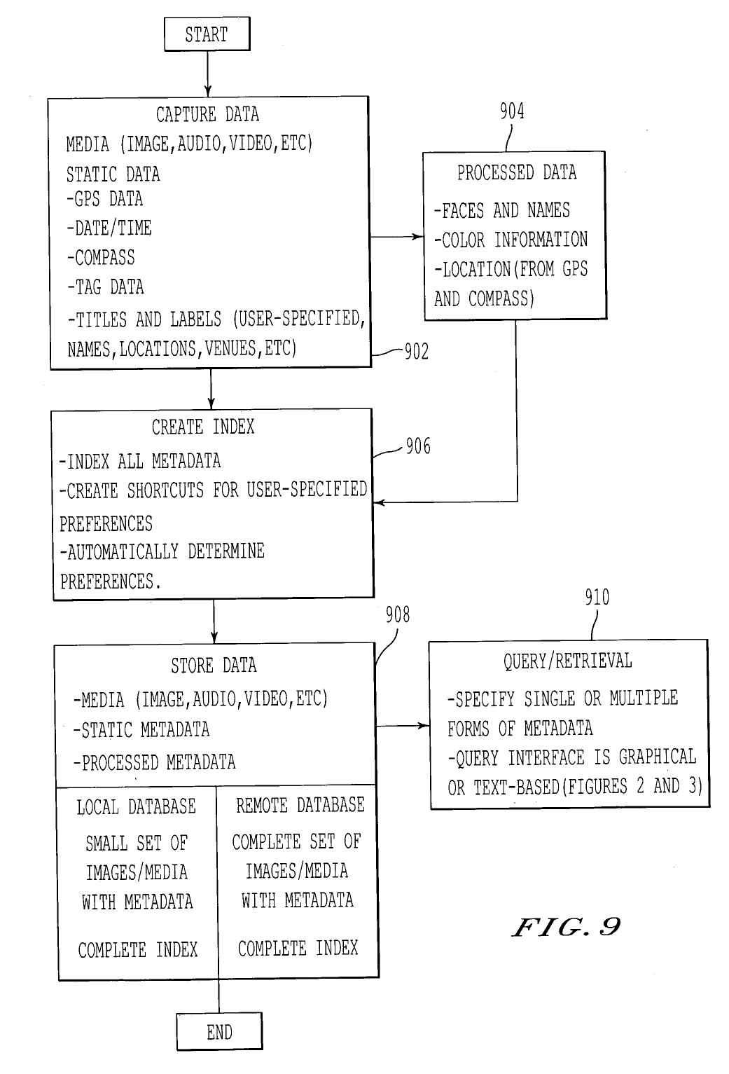

Alternatively, the captured data may be transmitted from the camera 100 via the communications device 110 to a remote computer for processing to create metadata, and to store the metadata. The server 208, for example, may be used as a remote computer with a database for storing the captured data indexed with the metadata for efficient storage and retrieval of the captured data. A communications device 110 having an appropriately configured interface is provided for enabling the camera 100 to communicate with various external devices in order to exchange image data as well as obtain metadata from the external devices, such as, for example, wireless communications device/personal trusted device 204, address book 206, computer system 208, and GPS system 210 as shown in FIG. 2.

Further referring to FIG. 1(a), a removable memory cartridge/stick slot 112 is also provided for storing captured information (video, image, or audio) for easy portability. It will be appreciated by one skilled in the art that other forms of portable storage media include DVD, CD-ROM, or such optical storage devices, or various other magnetic media may also be used. The camera 100 is also provided with a microphone 114 for capturing audio data.

FIG. 1(b) shows the back side of the camera 100 having a display 116 for displaying an image captured via lens 104. Also, the display 116 may be used to display information stored in removable media slot 112.

Referring to FIG. 2, there is shown a schematic of system overview to obtain metadata corresponding to data captured by the camera, in an exemplary embodiment of the present invention. The camera 100, the details of which are described in detail in FIG. 1(a), captures the image of a person 201 standing against a background of the San Francisco Golden Gate Bridge. The captured picture of the person 201 is displayed on the display device 116 (FIG. 1a) of the camera 100, and identified at 203 and stored in the storage device 106.

The metadata corresponding to the captured image 203 may be created by processing the captured data in the processor 108. For example, the processor may be loaded with image recognition software for enabling image recognition of the person 201 as “Dad” of the person operating the camera. Likewise, the Golden Gate Bridge may be recognized by the image recognition software of the camera 100. It will be appreciated by one skilled in the art that the captured images of “Dad” and the Golden Gate Bridge are compared against images stored in the storage device 106 of the camera 100.

Additional exemplary metadata includes information related to the following: GPS location, Date/time, Compass direction, Titles and labels (user-specified, names, locations, venues, etc.), Tag data (from Smart Tag devices, and devices using proximity protocols, such as Bluetooth, etc.), faces and names, color information, and location information (from GPS and Compass) . For example, the metadata may be stored in the form of key and value pairs.

The storage device 106 of the camera 100 may include a database having additional information related to the captured image. For example, such additional information may include the date and time at which the image is taken, personal information, such as birthday, contact information, etc. of the captured subject. The additional information may be retrieved as metadata for identified images. Personal information of an image subject may also be obtained from devices external to the camera 100 using the communications device 110.

Metadata corresponding to a captured image may include location/position information that may be obtained via GPS system. Once the location information is obtained via GPS, weather conditions at the time the picture was taken may be obtained by correlating the location information with meteorological sites accessed using computer system 208 provided with a capability to access the Internet or the World Wide Web (WWW) Exemplary metadata related to the captured image 203 is shown in FIG. 2. Indices are created from the metadata, and the captured images are stored according to the created indices.

As described above, location information of an imaging subject may be obtained using a GPS system. However, in the absence of a GPS system, neither the location information nor other information from other technological devices that are dependent on the location information as input from the GPS system may provide additional metadata for accurate indexing and retrieval of digital content.

Further referring to FIG. 2, once the date and time information is determined from the captured image content, further metadata is created by (1) establishing communication with an address book 206 of the camera owner and (2) retrieving any additional information stored in the address book for the corresponding date and time ranges. In this way, if the camera owner has an entry of “Camping with Mom and Dad,” for the corresponding date and time, such information can be used as automatically generated metadata. Instead of using the address book 206, other data management devices (such as calendars and personal organizers) capable of communicating with the camera 100 may also be used to obtain metadata corresponding to an image. The calendar 205 and address book 206 may be accessed via internet 207 by the camera 100. Other content, such as, Internet Favorite lists or hot list information of a user may also be used for creation of metadata.

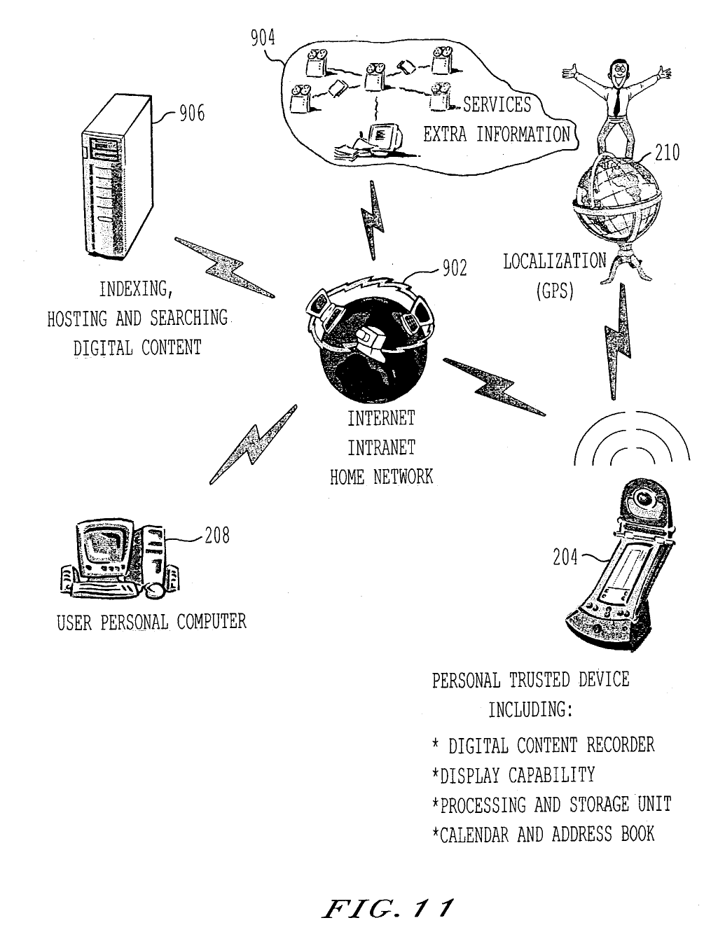

As shown in FIGS. 10-12, which are described in greater detail in the later paragraphs herein, the personal digital assistant (PDA) 908 may be provided with capability to store address book and calendar information. Alternatively, the personal trusted device 204 may be integrated with such capability, thus achieving multiple functionalities with a single device.

Thus, even in the absence of a GPS system, location information of an image subject can be determined with reasonable probability. The present invention not only enables the location of an image to be determined, but also helps to identify other entities/person(s) associated with the identified image. Also, once the image location is determined, then information regarding weather, temperature, etc. may easily be determined by correlating the position information with meteorological data available for that particular location.

Referring now to FIG. 3, there is shown a schematic of an exemplary computer system 208 for creating metadata related to a captured image by the camera 100. Referring now to the drawings, wherein like reference numerals designated identical or corresponding parts throughout the several views, FIG. 3 is a schematic illustration of a computer system for implementing the method and system according to the present invention. The computer system 208 has a housing 302 which houses a motherboard 304 which contains a CPU 306 (e.g. Intel Pentium, Intel Pentium II, P3, P4, Dec Alpha, IBM/Motorola Power PC, memory 308 (e.g. DRAM, ROM, EPROM, EEPROM, SRAM and Flash RAM), and other optional special purpose logic devices (e.g. ASICs) or configurable logic devices (e.g., GAL and reprogrammable FPGA). A communications device 316 enables communication between the computer system 208 and other external devices, such as, for example, the personal trusted device 204.

The computer 208 further includes plural input devices, (e.g., a keyboard 322 and mouse 324, and a display card 310 for controlling monitor 320. In addition the computer system 208 includes a floppy disk drive 314; other removable media devices (e.g., compact disc 319, tape, and removable magneto-optical media); and a hard disk 312, or other fixed, high density media drives, connected using an appropriate devices bus (e.g., a SCSI bus or an Enhanced IDE bus). Although compact disc 319 is shown in a disc caddy, the compact disc 319 can be inserted directly into CD-ROM drives which do not require caddies. Also connected to the same device bus or another device bus as the high density media drives the computer 208 may additionally include an optical disc (e.g., compact disc or DVD) reader 318, an optical disc reader/writer unit or an optical disc jukebox. In addition, a printer (not shown) also provides printed copies of desired images or indices.

The computer system 208 further includes at least one computer readable medium. Examples of such computer readable media area compact discs 319, hard disks 312, floppy disks, tape, magneto-optical disks, PROMs (EPROM, EEPROM, Flash EPROM), DRAM, SRAM. Stored on any one or on a combination of the computer readable media, the present invention includes software for controlling both the hardware of the computer 208 and for enabling the computer 208 to interact with a human user or other devices, such as, for example, a camera 100, a calendar 205, an address book 206, etc. Such software may include, but is not limited to, device drivers, operating systems and user application, such as development tools and (graphical) system monitors. Such computer readable media further include a computer program, according to the present invention, for processing and organization of image data.

FIG. 4A shows a system interface for indexing and retrieving captured information using the camera 100 (FIG. 2) in an exemplary embodiment of the present invention. As described in great detail at FIG. 2, images 402 and 404 are identified as the Golden Gate Bridge and the Grand Canyon, respectively, using information stored in the storage device 106 of the camera 100 or the storage device (hard disk) 312 of the computer system 208. Likewise, people shown in image 402 are recognized by the image recognition software from information 408 stored in the storage device 106.

Further referring to FIG. 4A, images 402, 404 may be indexed under “San Francisco” and “Grand Canyon”, respectively. Further, image 402 may also be indexed to be categorized under the names of the people identified in the image. For example, if “Michael” and “Serge” are recognized from image 402 and the image is indexed accordingly, then, upon selecting the attribute “Michael” from menu 408, all images associated with “Michael” would be retrieved. In the exemplary interface of FIG. 4A, image 402 would be retrieved and displayed. Likewise, if the attribute “Grand Canyon” is selected, image 404 associated with the “Grand Canyon” is retrieved and displayed. FIG. 4B shows an indexing and grouping scheme for images identified and described in FIG. 4A.

Referring to FIG. 5, there is shown a system architecture for a demonstration prototype in an exemplary embodiment of the present invention. Step 1 shows a live image capture at 502 of a journalist, and the captured image is set to a Golden Gate Group 504 and identified under the section Live Demo. The Stored Demo section includes images 402 and 404 shown in FIG. 4.

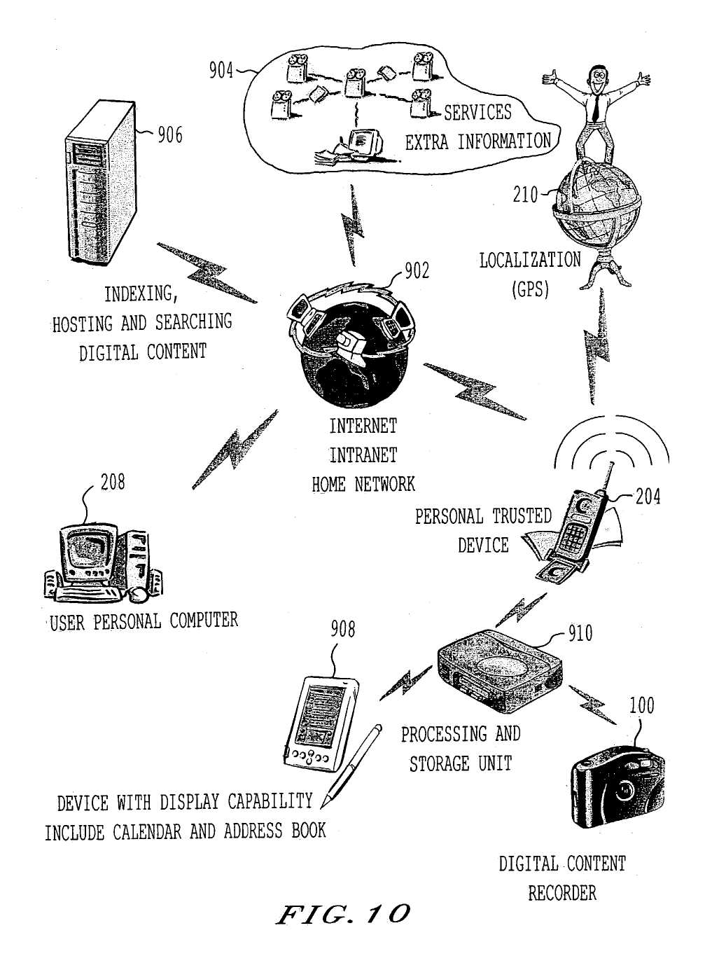

In the image processing and indexation step 2, labels and face association of the captured images is performed. The captured images having the Golden Gate background are stored under the label “Golden Gate” and “San Francisco” while the Grand Canyon image is stored under the label “Grand Canyon” and “Arizona or Utah.” In the retrieval step 3, when the “Golden Gate” or “San Francisco” are used as query terms, then the captured image 502 of the journalist set to the Golden Gate Group 504 is retrieved. In the Stored Demo section, upon specifying “Michael or Bridge” as query terms, image 402 is retrieved. Retrieved images may be viewed on a PDA 908 (FIG. 9) as explained in detail with respect to FIG. 9.

FIG. 6A illustrates a schematic for obtaining metadata corresponding to an image captured by the camera 100 in another exemplary embodiment of the present invention. More particularly, FIG. 6A shows the camera 100 being set to capture an image of a painting or art 602 physically located in a museum or the like. The details of the painting 602 may be described and listed on the painting itself for ready viewing by the public. In a preferred embodiment of the present invention, the details of the painting 602 may be programmed into a Smart Tag device 604 which is physically located adjacent to the painting. The Smart Tag device 604 is capable of communicating with another communication device if it is within the communication range of the Smart Tag device 604. Smart Tags, such as, for example, Radio Frequency Identification Tags (RFID), are active devices that have their own CPU and memory. Further, Smart Tags may be equipped with sensors or actuators, and are capable of exchanging data over radio interface (802.1504).

A user desiring to capture an image of the painting 602 using the camera 100, equipped with the communications device 110 (FIG. 1a), may bring the camera 100 into the communication range of the Smart Tag device 604 in order to enable the Smart Tag device to establish communication with the communications device 110 of the camera 100 when the painting 602 appears (at the time of image capture) in the digital content. Upon establishing communication between the Smart Tag device 604 of the painting 602 and the communications device 110, metadata, programmed into the Smart Tag device 604 and corresponding to the painting 602 may be transmitted to the camera 100 (if the painting appears in the captured digital content) for appropriate indexing and storage of the painting 602 within the storage device of the camera 100.

For example, the metadata may include such information as description of the painting, date when the painting was created, artist information, physical location of the painting, etc. The captured image data is indexed using the metadata obtained from the Smart Tag device 604. It will be appreciated that the captured information may also be stored on a removable storage or transmitted for storage on an external storage device, as explained in detail with respect to FIG. 1.

FIG. 6B shows another exemplary embodiment of the present invention wherein two sets of paintings 602a, 602b having respective Smart Tag devices 604a, 604b are disclosed. The process of exchanging metadata between the camera 100 and each of the Smart Tag devices 604a, 604b is similar to that which is described as in FIG. 6A, and therefore is not repeated herein. However, when the camera 100 is brought in close proximity to the painting 602a in order to capture an image of the painting, and if the camera 100 is brought within the communication range of each of the Smart Tag devices 604a and 604b, and thus receives metadata from both the devices, then one would have difficulty in correlating the received metadata from both the Smart Tag devices to the captured image of the painting 602a. The present invention overcomes the above-described problem by obtaining directional information from a digital compass in addition to the position information obtained from a GPS device. The digital compass may be provided within the camera 100 or independent of the camera 100 but in communication with the camera 100.

From the directional information, it is possible to identify a captured image among several displayed images. For example, if the camera 100 is aimed towards painting 602a, then using the directional information, the metadata obtained from the Smart Tag device 604a would be correlated to the image data of the painting 602a. Similar technique may be adopted in the embodiment described in FIG. 7 for indexing and retrieval purposes, if multiple paintings with corresponding Bluetooth communication devices are present.

In another exemplary embodiment of the present invention shown in FIG. 7, the painting 602 may be provided with a device 704 configured to operate using a Bluetooth protocol. The device 704 is provided with an interface 702 for transmitting metadata related to the painting to an external device, such as for example, a camera 100, which comes within the range of the device 704. In such a case, the communications device 110 (FIG. 1) of the camera 100 would also be preferably equipped with an interface 702 that is capable of communicating using a Bluetooth protocol with the device 704. Bluetooth is an open specification for technology that enables short-range wireless connections between desktop and laptop computers, personal digital assistants, cellular phones, printers, scanners, digital cameras and even home appliances—on a globally available band (2.4 GHz) for worldwide compatibility.

Referring now to FIGS. 8a through 8c, there are shown file structures/data structures for storing image data and corresponding metadata. Specifically, FIG. 8a shows an image or media file 802 and a corresponding metadata file 804, both stored in the storage 106 (FIG. 1). As noted earlier, a captured image data/media data and the metadata may also be stored in a removable storage device 112.

As can be seen from FIG. 8a, the metadata file 804 is stored separately from the image or media file 802, with the image or media file 802 having a link to the metadata file 804. The image or media file may be, for example, a JPEG, GIF, TIFF, MPEG, AVI, WAV file), and the metadata file may be stored in ASCII text or binary format. In FIG. 8B, the metadata is stored in the same bit-stream as the header information in field 807 or in a separate data field at another location within the same file structure, and the image data is separately stored in the field 808. In FIG. 8C, the metadata data is stored as a watermark 812 printed directly on the image 810. The watermark may be visible or hidden. In the case of printed images and media, the metadata may be printed on the front or back of a printed image.

The present invention finds applicability in the following illustrative Examples:

### EXAMPLE 1

### Insurance Industry

It is typical for an insurance company to send a claims adjuster to an accident scene to record images or other content related to the incident. For the case of image acquisition, the claims adjuster may have to take the image of the accident scene. The only automated data insertion may be date from the camera (assuming that the date is correctly set) . The claims adjuster may have to manually record all other information about the image.

However, using the present invention, metadata can be automatically collected. This includes, for example, the automatic insertion of the location of the accident with GPS, the directional information from a compass, information regarding street addresses from a content source, and the weather conditions at the time of the accident from a meteorological source.

Smart Tag or Bluetooth technology could be used to collect information about the automobile. For example, if the automobile is equipped with a Smart Tag device that is programmed with unique characteristics/information related to the automobile, such as, for example, license plate information, vehicle identification number, make/model/year/color, past accident information, tickets incurred with the automobile, etc. This additional data (metadata) may be automatically received by a camera (such as camera 100 (FIG. 1) when the claims adjuster is taking images of the accident scene. The metadata may be used for accurate indexing of the captured images.

Alternatively, before investigating an accident, the adjuster may put information about the accidents that he/she is going to investigate into his calendar program. Thus, when the images are recorded, the date and time can be used to retrieve such information from the calendar, thereby automatically recording the metadata about the accident with the photos of the scene or car.

### EXAMPLE 2

### Theme Parks, Museums, Sports Venues, and other Entertainment Arenas

In many of the most popular theme parks, several employees of the parks are assigned to take pictures of visitors entering the parks. The captured images provided, for a nominal fee, to the visitors. On several occasions, the images are taken in front of known locations in the theme park (such as for example, the globe in front of the Universal Studios, or with other famous characters). The Smart Tag technology of the present invention may be used to create metadata that could be used for searches for other related images.

Referring to FIG. 9, there is shown a general flow schematic for image capture, indexing, storage, and retrieval of the stored information. Step 902 illustrates a step of capturing image data. Image data is captured as illustrated in various embodiments of the present invention and described, for example, at FIGS. 2, 6A, 6B, and 7. The captured image data is processed in step 904 in order to obtain metadata corresponding to the captured data. The metadata is used to create an index for efficient storage and retrieval of the capture data, as shown in step 906. The captured data is stored, as shown in step 908, locally within the storage 106 (FIG. 1) of the camera 100, or it may be stored in a remote database (for example, hard disk 112 of computer system 208). The stored data is retrieved, as shown in step 910, by specifying single or multiple forms of metadata as search queries, and the query interface may preferably be graphical or text based as illustrated in FIGS. 4 and 5.

FIGS. 10 through 12 show various illustrative combinations and modifications that may be made to the illustrative example shown at FIG. 2. The camera 100 may be configured to communicate with a processing and storage unit 910. The processing and storage unit 910 may be substituted with another personal computer 208 capable of performing the processing and storage tasks for information captured by the camera 100. The processing and storage unit 910 is configured to communicate with other external devices, such as a person trusted device 204, a person digital assistant type of device 908 with capability to include a calendar and address book, and a GPS satellite system 210. The processing and storage unit 910 is also configured to communicate (preferably via a communications network, such as an internet or other packet switching network) with a server 906 that is capable of indexing, hosting, and searching digital content, a person computer system 208, and other devices communicatively linked to a network 904. Wired or wireless communication methods may be employed for enabling communication between each of the devices illustrated in FIGS. 10 through 12.

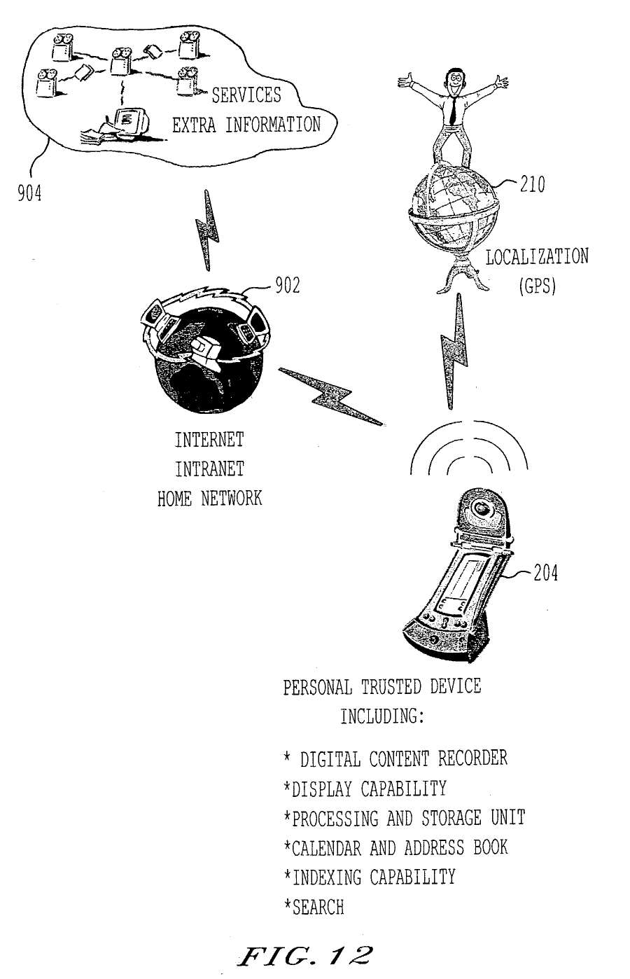

FIG. 11 and the operation thereof is similar to the one described in FIG. 10 with the exception that the personal trusted device 204 is capable of performing the functionalities of the camera 100, personal digital assistant type of device 908, and processing and storage unit 910. FIG. 12 is another variation of FIG. 11 wherein the personal trusted device 204 is further provided with capability to perform the functions of server 908, and person computer 208, as shown in FIGS. 11 and 12.

Although the present invention is shown to include a few devices, connected to network, it will be appreciated that more than a few devices may be connected to the network without deviating from the spirit and scope of the invention.

The processing of captured data in the present invention may be conveniently implemented using a conventional general purpose digital computer or a microprocessor programmed according to the teachings of the present specification, as will be apparent to those skilled in the computer art. Appropriate software coding can readily be prepared by skilled programmers based on the teachings of the present disclosure, as will be apparent to those skilled in the software art. Processing of captured data may also be performed by the preparation of application specific integrated circuits or by interconnecting an appropriate network of conventional component circuits, as will be readily apparent to those skilled in the art.

Obviously, numerous modifications and variations of the present invention are possible in light of the above teachings. It is therefore to be understood that within the scope of the appended claims, the invention may be practiced otherwise than as specifically described herein.

What is claimed is:

1. An image processing method comprising:
a) capturing an image in digital form;
b) storing the image as an image file;
c) communicating with at least one device for retrieving metadata stored therein corresponding to an object of the stored image file;
d) storing in an index file the metadata and a reference to the stored image file; and
e) retrieving the stored image file by querying at least one field of the index file.

2. The method as in claim 1, wherein storing the index file comprises storing in a database.

3. The method as in claim 1, wherein retrieving comprises performing a database search.

4. The method as in claim 1, further comprising rearranging plural stored images into groups determined by a user.

5. The method as in claim 1, further comprising:
displaying the retrieved image on a display device.

6. The method as in claim 4, further comprising:
adding additional images to a group defined by the user.

7. The method as in claim 1, further comprising referencing the image file in more than one index file.

8. The method as in claim 1, further comprising:
allowing a user to set an image to a specific geographic location.

9. The method as in claim 1, wherein:
the step of retrieving comprises using a graphical or text-based interface.

10. The method as in claim 1, wherein the step of communicating comprises using wired or wireless communications.

11. The method as claimed in claim 1, further comprising determining at least one person in the image using image recognition software.

12. The method as claimed in claim 1, wherein the device is a remote device.

13. The method as in claim 12, wherein the remote device is an address book capable of communicating with a camera.

14. The method as in claim 12, wherein the remote device is a calendar capable of communicating with a camera.

15. The method as in claim 1, wherein the device is a PDA capable of communicating with a camera.

16. The method as claimed in claim 1, wherein the step of communicating comprises communicating with a smart tag device.

17. The method as claimed in claim 1, wherein the step of communicating comprises communicating with a Bluetooth device.

18. A method of storing, indexing and retrieval of a plurality of images, comprising:
storing the plurality of images in digital form;
retrieving metadata, corresponding to the plurality of stored images, from a database; and
grouping the plurality of stored images using the metadata obtained from the database.

19. The method as in claim 18, wherein the step of grouping comprises grouping using time information.

20. The method as claimed in claim 19, wherein grouping using time information comprises grouping images together that correspond to the same event in a calendar.

21. An image processing apparatus comprising:
a camera for capturing an image in digital form;
a storage device for storing the image as an image file;
a communications device for enabling communication with at least one device in order to retrieve metadata stored therein corresponding to an object of the stored image file; and
said storage device storing in an index file the metadata and a reference to the stored image file.

22. The apparatus as in claim 21, wherein the index file is stored in a database comprised in said storage device.

23. The apparatus as in claim 21, wherein:
plural stored images are rearranged into groups determined by a user.

24. The apparatus as in claim 21, further comprises:
a display device for displaying the retrieved image.

25. The apparatus as in claim 23, wherein said apparatus is configured to add additional images to a group defined by the user.

26. The apparatus as in claim 21, wherein the image file is referenced in more than one index file.

27. The apparatus as in claim 21, wherein a user is allowed to set an image to a specific geographic location.

28. The apparatus as in claim 21, wherein:
a graphical or text-based interface is used for retrieving the stored image file by querying at least one field of the index file.

29. The apparatus as in claim 21, wherein wired or wireless communications is used for communicating with the at least one device.

30. The apparatus as in claim 21, wherein image recognition software stored in said storage device is used for determining at least one person in the image.

31. The apparatus as in claim 21, wherein the device is a remote device.

32. The apparatus as in claim 31, wherein the remote device is an address book capable of communicating with a camera.

33. The apparatus as in claim 31, wherein the remote device is a calendar capable of communicating with a camera.

34. The apparatus as in claim 21, wherein the device is a PDA capable of communicating with a camera.

35. The apparatus as in claim 21, wherein the communications device communicates with a smart tag device.

36. The apparatus as in claim 21, wherein the communications device communicates with a Bluetooth device.

37. An apparatus for storing, indexing and retrieval of a plurality of images, comprising:
a storage device for storing the plurality of images in digital form; and
a database for storing metadata corresponding to the plurality of stored images, wherein
the plurality of stored images are organized using the metadata obtained from the database.

38. The apparatus as in claim 37, wherein the plurality of stored images are organized using time information.

39. The apparatus as in claim 38, wherein organizing the plurality of images using time information is performed by grouping images together that correspond to the same event in a calendar.
